(19) United States
(12) Patent Application Publication
(10) Pub. No.: US 2004/0103738 A1
(43) Pub. Date: Jun. 3, 2004

(54) 3~6-DOF decoupling structure parallel micromanipulator

(75) Inventors: Feng Gao, Tianjin (CN); Jianjun Zhang, Tianjin (CN); Weimin Li, Tianjin (CN); Hui Zhao, Tianjin (CN); Binbin Peng, Tianjin (CN)

Correspondence Address: LACKENBACH SIEGEL, ONE CHASE ROAD, SCARSDALE, NY, 10583, US

(73) Assignee: Hebei University of Technology, Tianjin (CN)

(21) Appl. No.: 10/419,497

(22) Filed: Apr. 21, 2003

(30) Foreign Application Priority Data
May 23, 2002 (CN) 02117851.8

(51) Int. Cl. B25J 17/00

(52) U.S. Cl. 74/490.01

(57) ABSTRACT

3˜6-DOF decoupling structure modular reconfigurable parallel micromanipulator can be configured to different structures and degrees of freedom for different task requirement and work environment. Integral structure of reconfigurable modules like fixed platform module, 2-PSS limb module, 2-PUS limb module, 1-PSS limb module, 2-PUS limb module, 1-PUU limb module, moving platform module and driver module are described. Decoupling structure parallel micromanipulators of 3-, 4-, 5- and 6-DOF are constructed by the reconfigurable modules and theirs structure is described in detail. The invention has the merits of multiplicity and multifunction. What's more, it can solve the problem of the rather large assembly error in the full assembly and the baddish manufacturing process in the integral structure.

### FIELD OF THE INVENTION

The invention relates in general to advanced manufacture, and more particularly, to 3˜6-DOF decoupling structure modular reconfigurable parallel micromanipulator and the like.

### BACKGROUND OF THE INVENTION

The ideal of modularization is to design with standardized units or dimensions for easy assembly and repair or flexible arrangement and use. A fully modular reconfigurable robot consisting of a set of standardized modules can be configured to different structures and degrees of freedom for different task requirement. In recent years the concept of modularization has been introduced in the design of the parallel manipulators for flexibility, economy, ease of maintenance, and rapid deployment. A modular reconfigurable parallel robot has been developed by Yang and Chen who belong to Gintic manufacturing engineering research institute and Nanyang technological university respectively, Singapore. Professor Hamlin, Rensselaer technological research institute, USA, has designed a modular reconfigurable parallel robot, Tetrobot. The spherical joints used in the Terobot are novel mechanism known as the concentric multi-link spherical (CMS) joint, which allows an arbitrary number of links to be connected to a common center of rotation. Under the support of the NIST, a modular reconfigurable experimental Stewart platform has been developed by Zhiming Ji of New Jersey engineering college, USA. He also studied the pose parameter identification. In china there is no relevant report on the modular reconfigurable parallel robot.

The flexible joints used in parallel micromanipulator substitute for the actual ones, which may not only eliminate the general clearance, friction but also have a number of intrinsic properties such as high rigid and high degree of accuracy. Professor Feng Gao of Heibei University of Technology(China) have acquired a serial of invention patents in 3, 4, 5, 6-DOF decoupling structure parallel micromanipulator field in China, the Patent No. are ZL99121020.4 □ZL00100196.5 □ZL 00100197.3 □ZL 00100198.1. At the present time there is only two means for the manufacture of the parallel micromanipulator, full assembly and integral structure. The full assembly through which the manipulator is assembled by a series of parts is the general means applied in the manufacture. But a rather large assembly error can be existed in the robot system by this means. The means of integral structure would not produce assembly error at the cost of baddish manufacturing process. For these reasons given above, we present a kind of decoupling structure modular reconfigurable micromanipulator, which can not only overcome the deficiency described above to some extent but also configure to some different decoupling structure parallel micromanipulators. To now, there is no report on decoupling structure modular reconfigurable parallel micromanipulator all over the world.

### BRIEF DESCRIPTION OF THE INVENTION

The object of the invention is to provide 3˜6-DOF decoupling structure parallel micromanipulator which is composed by reconfigurable modules.

Yet another object of the invention is to provide 3˜6-DOF decoupling structure modular reconfigurable parallel micromanipulator which avoids assembly error of the full assembly one and baddish manufacturing process of the integral structure one.

In accordance with the present invention, the 3˜6-DOF decoupling structure modular reconfigurable parallel micromanipulator consists of fixed platform module with three reciprocal orthogonal mounting surfaces on which there are connecting holes, limb modules, driver module and moving platform module. The limb modules connect the fixed platform module and moving platform via three reciprocal orthogonal directions respectively. And there are six kinds of limb module which could be chosen to configure decoupling structure parallel micromanipulator of 3-, 4-, 5- and 6-DOF.

The structure of 2-PSS limb module is integrated two same direct kinetic limbs each of which consists of one flexible prismatic pair, one link and two flexible spherical joints into one. The two flexible prismatic pairs of the 2-PSS limb module are fixed parallel on the chassis on which there are connecting holes. Additionally, the axes of the two links are parallel, at the end of which are connected with flexible spherical joints respectively. Two flexible spherical joints are mounted on the two flexible prismatic pairs, and the other two flexible spherical joints are fixed on the quadrate strut which would be utilized to connect with the moving platform.

The structure of 2-PUS limb module is same with the structure of 2-PSS limb module except that the two flexible spherical joints mounted on the two flexible prismatic pairs are substituted by two flexible universal joints.

The structure of 2-PUU limb module is same with the structure of 2-PSS limb module except that the four flexible spherical joints are substituted by four flexible universal joints.

The structure of 1-PSS limb module is one kinetic limb which integrates with one flexible prismatic pair, one link and two flexible spherical joints. The flexible prismatic pair of the 1-PSS limb module is fixed on the chassis on which there are connecting holes. Additionally, the two flexible spherical joints are fixed at the two end of link respectively. One flexible spherical joint is mounted on the flexible prismatic pair, and the other flexible spherical joint is fixed on the quadrate strut which would be utilized to connect with the moving platform.

The structure of 1-PUS limb module is same with the structure of 1-PSS limb module except that the flexible spherical joint mounted on the flexible prismatic pair is substituted by one flexible universal joint.

The structure of 1-PUU limb module is same with the structure of 1-PSS limb module except that the two flexible spherical joints are substituted by two flexible universal joints.

The fixed platform module possesses three reciprocal orthogonal mounting surfaces with connecting holes. The chassis of limb module would be located on the surface and fixed by the connecting holes.

The moving platform module would be the moving platform of micromanipulator. It is a cube with six quadrate notches on its three reciprocal orthogonal mounting surfaces which would be utilized to connect with the limb modules.

The driver module is the piezoelectric ceramic driver and is installed between the flexible place of the limb module's prismatic pair and the chassis.

These standardized modules, such as fixed platform module, suitable limb modules, moving platform module and driver module can be configured to some special 3˜6-DOF decoupling structure parallel micromanipulators.

In symbol of the limb modules, the Arabic number is denoted the number of the kinetic limb, P is denoted the flexible prismatic pair of one DOF, U for the flexible universal joint of two DOF and S for the flexible spherical joint of three DOF.

The following is the technical advantage of the present invention compared with the others:

3˜6-DOF decoupling structure modular reconfigurable parallel micromanipulator can be configured to different structures and degrees of freedom for different task requirement and work environment. So it has the merits of multiplicity and multifunction. What's more, it can solve the problem of the rather large assembly error in the full assembly and the baddish manufacturing process in the integral structure. The presentation of the invention will have a great influence in the field of manufacture. Besides, it can be applied extensively in these fields of fine operation and machining, micro manufacture, inching platform, integrated circuit production, biologic and genetic engineering and microsurgery.

### DETAILED DESCRIPTION OF THE INVENTION

The foregoing and further features and objects of the invention will more readily be understood from the following detailed description of the invention, when taken in conjunction with the accompanying drawings in which:

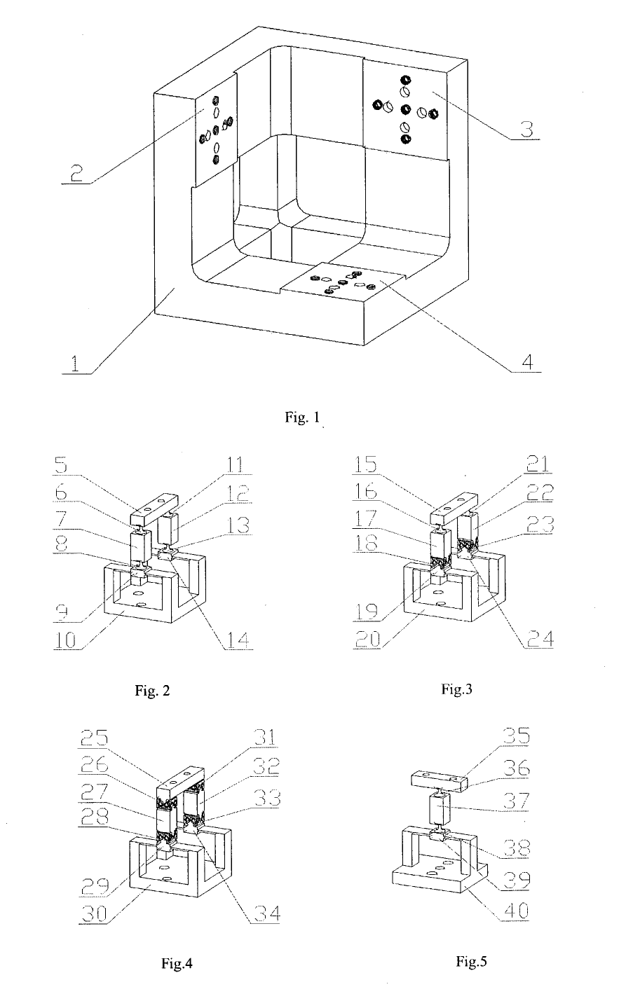

FIG. 1 is a view of the structure of fixed platform module;

FIG. 2 is a view of the structure of 2-PSS limb module;

FIG. 3 is a view of the structure of 2-PUS limb module;

FIG. 4 is a view of the structure of 2-PUU limb module;

FIG. 5 is a view of the structure of 1-PSS limb module;

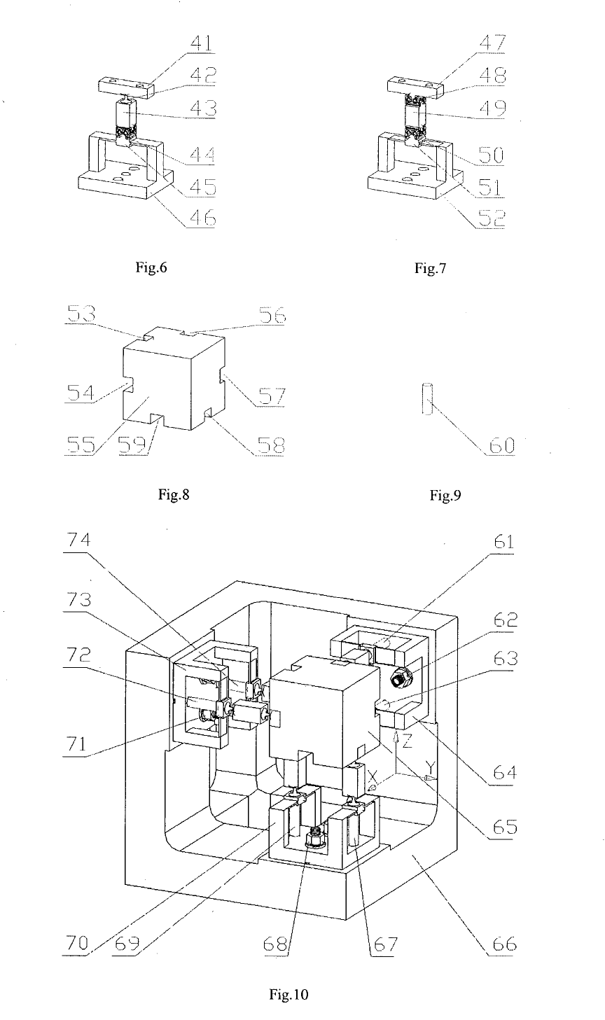

FIG. 6 is a view of the structure of 1-PUS limb module;

FIG. 7 is a view of the structure of 1-PUU limb module;

FIG. 8 is a view of the structure of moving platform module;

FIG. 9 is a view of the structure of driver module;

FIG. 10 is a view of the structure of 6-PSS(6-DOF) decoupling structure modular parallel micromanipulator;

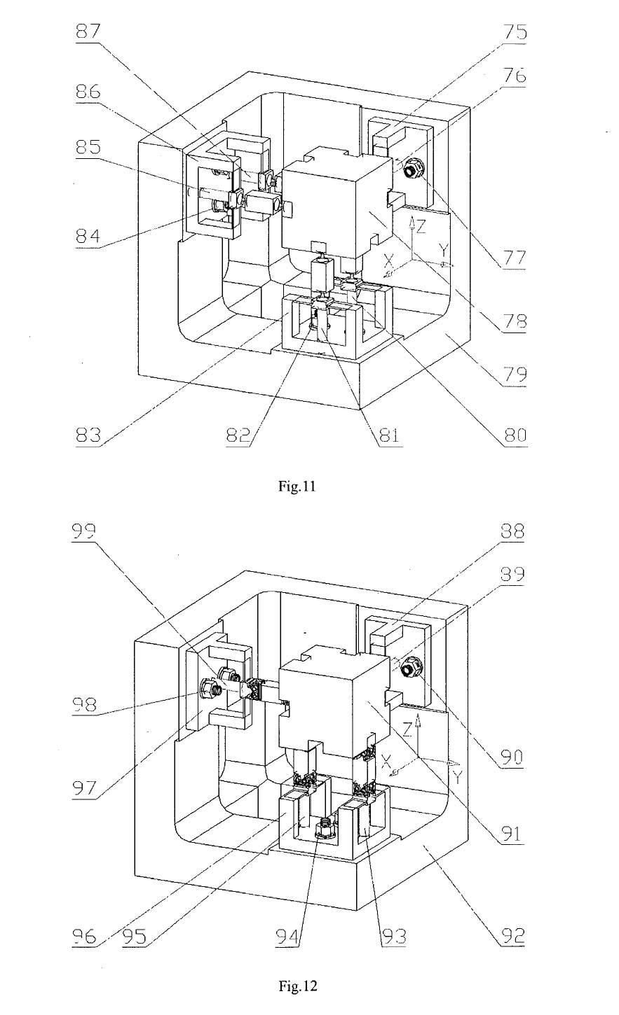

FIG. 11 is a view of the structure of 4-PSS&1-PUU(5-DOF) decoupling structure modular parallel micromanipulator;

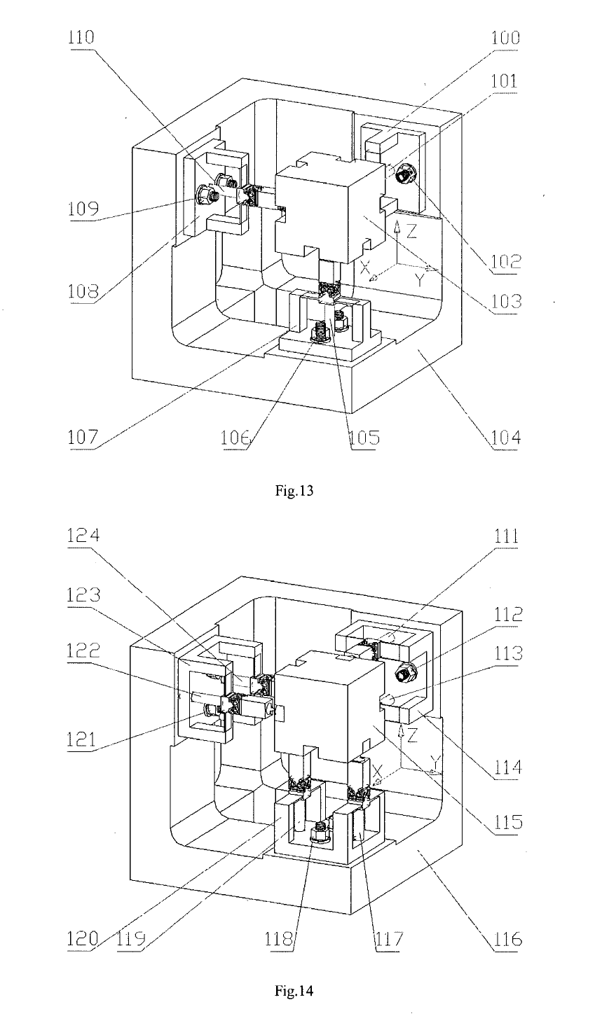

FIG. 12 is a view of the structure of 3-PUU&1-PSS(4-DOF) decoupling structure modular parallel micromanipulator;

FIG. 13 is a view of the structure of 3-PUU(3-DOF) decoupling structure modular parallel micromanipulator;

FIG. 14 is a view of the structure of 6-PUS(6-DOF) decoupling structure modular parallel micromanipulator.

### EXAMPLE 1

The structures of all the modules are shown in FIG. 1, FIG. 2, FIG. 3, FIG. 4, FIG. 5, FIG. 6, FIG. 7, FIG. 8 and FIG. 9.

The structure of the fixed platform module is shown in FIG. 1. It has three reciprocal orthogonal mounting surfaces 2, 3 and 4. On each mounting surface, there are connecting holes through which the fixed platform can be connected with the limb modules.

The structure of 2-PSS limb module shown in FIG. 2 is integrated two same direct kinetic limbs each of which consists of one flexible prismatic pair, one link and two flexible spherical joints into one. The two flexible prismatic pairs 9 and 14 of the 2-PSS limb module are fixed parallel on the chassis 10 on which there are connecting holes. Additionally, the axes of the two links 7 and 12 are parallel, at the end of which are connected with flexible spherical joints 6 and 8, 11 and 13 respectively. Two flexible spherical joints 8 and 13 are mounted on the two flexible prismatic pairs 9 and 14, and the other two flexible spherical joints 6 and 11 are fixed on the quadrate strut 5 which would be utilized to connect with the moving platform.

The structure of 2-PUS limb module shown in FIG. 3 is integrated two same direct kinetic limbs each of which consists of one flexible prismatic pair, one link, one flexible universal joint and one flexible spherical joint into one. The two flexible prismatic pairs 19 and 24 of the 2-PUS limb module are fixed parallel on the chassis 20 on which there are connecting holes. Additionally, the axes of the two links 17 and 22 are parallel, at the end of which are connected with one flexible universal joint and one flexible spherical joint 18 and 16, 23 and 21 respectively. The two flexible universal joints 18 and 23 are mounted on the two flexible prismatic pairs 19 and 24, and the two flexible spherical joints 16 and 21 are fixed on the quadrate strut 15 which would be utilized to connect with the moving platform.

The structure of 2-PUU limb module shown in FIG. 4 is integrated two same direct kinetic limbs each of which consists of one flexible prismatic pair, one link and two flexible universal joints into one. The two flexible prismatic pairs 29 and 34 of the 2-PUU limb module are fixed parallel on the chassis 30 on which there are connecting holes. Additionally, the axes of the two links 27 and 32 are parallel, at the end of which are connected with flexible universal joints 28 and 26, 33 and 31 respectively. Two flexible universal joints 28 and 33 are mounted on the two flexible prismatic pairs 29 and 34, and the other two flexible universal joints 26 and 31 are fixed on the quadrate strut 25 which would be utilized to connect with the moving platform.

The structure of 1-PSS limb module shown in FIG. 5 is one kinetic limb which integrates with one flexible prismatic pair, one link and two flexible spherical joints. The flexible prismatic pair 39 of the 1-PSS limb module is fixed on the chassis 40 on which there are connecting holes. Additionally, the two flexible spherical joints 36 and 38 are fixed at the two end of link 37 respectively. One flexible spherical joint 38 is mounted on the flexible prismatic pair 39, and the other flexible spherical joint 36 is fixed on the quadrate strut 35 which would be utilized to connect with the moving platform.

The structure of 1-PUS limb module shown in FIG. 6 is one kinetic limb which integrates with one flexible prismatic pair, one link, one flexible universal joint and one flexible spherical joint. The flexible prismatic pair 45 of the 1-PUS limb module is fixed on the chassis 46 on which there are connecting holes. Additionally, the flexible universal joint 44 and the flexible spherical joint 42 are fixed at the two end of link 43 respectively. The flexible universal joint 44 is mounted on the flexible prismatic pair 45, and the flexible spherical joint 42 is fixed on the quadrate strut 41 which would be utilized to connect with the moving platform.

The structure of 1-PUU limb module shown in FIG. 7 is one kinetic limb which integrates with one flexible prismatic pair, one link and two flexible universal joints. The flexible prismatic pair 51 of the 1-PUU limb module is fixed on the chassis 52 on which there are connecting holes. Additionally, the two flexible universal joints 50 and 48 are fixed at the two end of link 49 respectively. One flexible universal joint 50 is mounted on the flexible prismatic pair 51, and the other flexible universal joint 48 is fixed on the quadrate strut 47 which would be utilized to connect with the moving platform.

The moving platform module 55 shown in FIG. 8 would be the moving platform of micromanipulator. It is a cube with six quadrate notches 53, 54, 56, 57, 58 and 59 on its three reciprocal orthogonal mounting surfaces which would be utilized to connect with the limb modules.

### EXAMPLE 2

The structure of the 6-PSS(6-DOF) decoupling structure modular parallel micromanipulator is shown in FIG. 10. The chassis of the three 2-PSS limb modules 64, 70 and 73 are installed on the three reciprocal orthogonal mounting surfaces of the fixed platform module 66 through three groups of standardized components 62, 68 and 71 respectively. What's more, it would be sure that the quadrate struts of the limb modules 64, 70 and 73 are reciprocal orthogonal. Thus the link axes of the three limb modules noted 2-PSS are arranged reciprocal orthogonally. The three quadrate struts of the 2-PSS limb modules 64, 70 and 73 and the three quadrate notches of the moving platform module 65 are matched reciprocally and are mounted together by the standardized components. Six drivers 61, 63, 67, 69, 72 and 74 are installed between the flexible place of the limb module's prismatic pairs and the chassis respectively. The six piezoelectric ceramic drivers drive the six flexible prismatic pairs and the moving platform could have six dimensions decoupling motion: translation along axis x, y or z and rotation about axis x, y or z.

### EXAMPLE 3

The structure of the 4-PSS&1-PUU(5-DOF) decoupling structure modular parallel micromanipulator is shown in FIG. 11. The chassis of two 2-PSS limb modules 83 and 86 and one 1-PUU limb module 75 are installed on the three reciprocal orthogonal mounting surfaces of the fixed platform module 79 through three groups of standardized components 82, 84 and 77 respectively. What's more, it would be sure that the axes of the quadrate struts of the two 2-PSS limb modules 83 and 86 are oriented the axis x, and the axes of the quadrate strut of the 1-PUU limb module 75 is oriented the axis z. Thus the link axes of the three limb modules 75, 83 and 86 are arranged reciprocal orthogonally. The quadrate struts of the three limb modules and the three quadrate notches of the moving platform module 78 are matched reciprocally and are mounted together by the standardized components. Five drivers 80, 81, 85, 87 and 76 are installed between the flexible place of the limb module's prismatic pairs and the chassis respectively.

The five piezoelectric ceramic drivers drive the five flexible prismatic pairs and the moving platform could have five dimensions decoupling motion: translation along axis x, y or z and rotation about axis y or z.

If the two 2-PSS limb modules mentioned above are substituted by two 2-PUS limb modules, the reconfigured parallel micromanipulator noted 4-PUS&1-PUU(5-DOF) has the same kinetic characteristics to the 4-PSS&1-PUU(5-DOF) decoupling structure modular parallel micromanipulator.

### EXAMPLE 4

The structure of 3-PUU&1-PSS(4-DOF) decoupling structure modular parallel micromanipulator is shown in FIG. 12. The chassis of the 2-PUU limb module 96, the 1-PUU limb module 97 and the 1-PSS limb module 88 are installed on the three reciprocal orthogonal mounting surfaces of the fixed platform module 92 through three groups of standardized components 94, 98 and 90 respectively. What's more, it would be sure that the axes of the quadrate strut of the 2-PUU limb module 96 is oriented the axis y and the axes of the quadrate struts of the 1-PUU limb module 97 and the 1-PSS limb module 88 are oriented the axis z. Thus the link axes of the three limb modules 96, 97 and 88 are arranged reciprocal orthogonally. The quadrate struts of the three limb modules and the three quadrate notches of the moving platform module 91 are matched reciprocally and are mounted together by the standardized components. Four drivers 93, 95, 99 and 89 are installed between the flexible place of the limb module's prismatic pairs and the chassis respectively.

The four piezoelectric ceramic drivers drive the four flexible prismatic pairs and the moving platform could have four dimensions decoupling motion: translation along axis x, y or z and rotation about axis x.

If the 1-PSS limb module mentioned above is substituted by the 1-PUS limb module, the reconfigured parallel micromanipulator noted 3-PUU&1-PUS(4-DOF) has the same kinetic characteristics to the 3-PUU&1-PSS(4-DOF) decoupling structure modular parallel micromanipulator.

### EXAMPLE 5

The structure of the 3-PUU(3-DOF) decoupling structure modular parallel micromanipulator is shown in FIG. 13. The chassis of three 1-PUU limb modules 100, 107 and 108 are installed on the three reciprocal orthogonal mounting surfaces of the fixed platform module 104 through three groups of standardized components 102, 106 and 109 respectively. What's more, it would be sure that the axis of the quadrate strut of the 1-PUU limb module 107 is oriented the axis y and the axes of the quadrate struts of the two 1-PUU limb modules 100 and 108 are oriented the axis z. Thus the link axes of the three 1-PUU limb modules are arranged reciprocal orthogonally. The quadrate struts of the three 1-PUU limb modules 100, 107 and 108 and the three quadrate notches of the moving platform module 103 are matched reciprocally and are mounted together by the standardized components. Three drivers 101, 105 and 110 are installed between the flexible place of the limb module's prismatic pairs and the chassis respectively.

The three piezoelectric ceramic drivers drive the three flexible prismatic pairs and the moving platform could have three dimensions decoupling motion: translation along axis x, y or z.

### EXAMPLE 6

The structure of the 6-PUS(6-DOF) decoupling structure modular parallel micromanipulator is shown in FIG. 14. In fact this structure can be easily reconfigured substituted the 2-PUS limb modules for the 2-PSS limb modules of the 6-PSS decoupling structure modular parallel micromanipulator. Both structures have the same kinetic characteristics. The chassis of three 2-PUS limb modules 114, 120 and 123 are installed on the three reciprocal orthogonal mounting surfaces of the fixed platform module 116 through three groups of standardized components 112, 118 and 121 respectively. What's more, it would be sure that the quadrate struts of the limb modules 114, 120 and 123 are reciprocal orthogonal. Thus the link axes of the three 2-PUS limb modules 114, 120 and 123 are arranged reciprocal orthogonally. The three quadrate struts of the 2-PUS limb modules 114, 120 and 123 and the three quadrate notches of the moving platform module 115 are matched reciprocally and are mounted together by the standardized components. Six drivers 111, 113, 117, 119, 122 and 124 are installed between the flexible place of the limb module's prismatic pairs and the chassis respectively.

The six piezoelectric ceramic drivers drive the six flexible prismatic pairs and the moving platform could have six dimensions decoupling motion: translation along axis x, y or z and rotation about axis x, y or z.

Having illuminated and described my invention, I claim:

1. a 3˜6-DOF decoupling structure parallel micromanipulator characterized in that the micromanipulator being with modular structure and can be reconfigured, the micromanipulator comprising: a fixed platform module, a plurality of driver modules, a plurality of limb modules and a moving platform module, said fixed platform module having three reciprocal orthogonal mounting surfaces and connecting holes, said fixed platform connects with said moving platform module via said driver modules and said limb modules.

2. a 3˜6-DOF decoupling structure parallel micromanipulator according to claim 1 possesses the characters:
The structure of said limb module is a 2-PSS limb module integrated two same direct kinetic limbs each of which consists of one flexible prismatic pair, one link and two flexible spherical joints into one. The two flexible prismatic pairs 9 and 14 of the 2-PSS limb module are fixed parallel on a chassis 10 of the limb module on which there are connecting holes. Additionally, the axes of the two links 7 and 12 are parallel, at the end of which are connected with flexible spherical joints 6 and 8, 11 and 13 respectively, Two flexible spherical joints 8 and 13 are mounted on the two flexible prismatic pairs 9 and 14, and the other two flexible spherical joints 6 and 11 are fixed on the quadrate strut 5 which would be utilized to connect with the moving platform.

3. a 3˜6-DOF decoupling structure parallel micromanipulator according to claim 1 possesses the characters:
The structure of limb module is 2-PUS limb module integrated two same direct kinetic limbs each of which consists of one flexible prismatic pair, one link, one flexible universal joint and one flexible spherical joint into one, The two flexible prismatic pairs 19 and 24 of the 2-PUS limb module are fixed parallel on a chassis 20 of the limb module on which there are connecting holes. Additionally, the axes of the two links 17 and 22 are parallel, at the end of which are connected with one flexible universal joint and one flexible spherical joint 18 and 16, 23 and 21 respectively. The two flexible universal joints 18 and 23 are mounted on the two flexible prismatic pairs 19 and 24, and the two flexible spherical joints 16 and 21 are fixed on the quadrate strut 15 which would be utilized to connect with the moving platform.

4. a 3˜6-DOF decoupling structure parallel micromanipulator according to claim 1 possesses the characters:
The structure of limb module is a 2-PUU limb module integrated two same direct kinetic limbs each of which consists of one flexible prismatic pair, one link and two flexible universal joints into one. The two flexible prismatic pairs 29 and 34 of the 2-PUU limb module are fixed parallel on a chassis 30 of the limb module on which there are connecting holes. Additionally, the axes of the two links 27 and 32 are parallel, at the end of which are connected with flexible universal joints 28 and 26, 33 and 31 respectively. Two flexible universal joints 28 and 33 are mounted on the two flexible prismatic pairs 29 and 34, and the other two flexible universal joints 26 and 31 are fixed on the quadrate strut 25 which would be utilized to connect with the moving platform.

5. a 3˜6-DOF decoupling structure parallel micromanipulator according to claim 1 possesses the characters:
The structure of limb module is one kinetic limb which integrates with one flexible prismatic pair, one link and two flexible spherical joints. The flexible prismatic pair 39 of the 1-PSS limb module is fixed on a chassis 40 of the limb module on which there are connecting holes. Additionally, the two flexible spherical joints 36 and 38 are fixed at the two end of link 37 respectively. One flexible spherical joint 38 is mounted on the flexible prismatic pair 39, and the other flexible spherical joint 36 is fixed on the quadrate strut 35 which would be utilized to connect with the moving platform.

6. a 3˜6-DOF decoupling structure parallel micromanipulator according to claim 1 possesses the characters:
The structure of limb module is one kinetic limb which integrates with one flexible prismatic pair, one link, one flexible universal joint and one flexible spherical joint. The flexible prismatic pair 45 of the 1-PUS limb module is fixed on a chassis 46 of the limb module on which there are connecting holes. Additionally, the flexible universal joint 44 and the flexible spherical joint 42 are fixed at the two end of link 43 respectively. The flexible universal joint 44 is mounted on the flexible prismatic pair 45, and the flexible spherical joint 42 is fixed on the quadrate strut 41 which would be utilized to connect with the moving platform.

7. a 3˜6-DOF decoupling structure parallel micromanipulator according to claim 1 possesses the characters:
The structure of limb module is one kinetic limb which integrates with one flexible prismatic pair, one link and two flexible universal joints. The flexible prismatic pair 51 of the 1-PUU limb module is fixed on a chassis 52 of the limb module on which there are connecting holes. Additionally, the two flexible universal joints 50 and 48 are fixed at the two end of link 49 respectively. One flexible universal joint 50 is mounted on the flexible prismatic pair 51, and the other flexible universal joint 48 is fixed on the quadrate strut 47 which would be utilized to connect with the moving platform.

8. a 3˜6-DOF decoupling structure modular reconfigurable parallel micromanipulator according to claim 1 possesses the characters:
The moving platform module 55 would be the moving platform of micromanipulator. It is a cube with six quadrate notches 53, 54, 56, 57, 58 and 59 on its three reciprocal orthogonal mounting surfaces which would be utilized to connect with the limb modules.

9. a 3˜6-DOF decoupling structure modular reconfigurable parallel micromanipulator according to claim 1 possesses the characters:
The driver module 60 is the piezoelectric ceramic driver and is installed between a flexible place of the limb module's prismatic pair and a chassis of the limb module.
